(19) United States
(12) Patent Application Publication
(10) Pub. No.: US 2013/0191922 A1
(43) Pub. Date: Jul. 25, 2013

(54) USER PROMPTED METADATA REMOVAL

(71) Applicant: John RIGAS, River Forest, IL (US)

(72) Inventor: John RIGAS, River Forest, IL (US)

(73) Assignee: Freedom Solutions Group, LLC d/b/a Microsystems, Downers Grove, IL (US)

(21) Appl. No.: 13/356,067

(22) Filed: Jan. 23, 2012

(51) Int. Cl. G06F 21/24

(52) U.S. Cl. 726/26

(57) ABSTRACT

Methods and apparatuses for the removal of metadata include the removal of metadata from an artifact accompanying a message. In a mobile communication device, a method for removing metadata from an artifact accompanying a message includes displaying at least one prompt via a user interface of the mobile communication device. Further, the method includes receiving, from a user of the mobile communication device via the user interface in response to the at least one prompt, metadata removal preference data. Cleansing instructions based on the metadata removal preference data are created and the message, the cleansing instructions, and the artifact are sent to a delivery system. The delivery system removes metadata from the artifact based on the cleansing instructions.

### FIELD

The instant disclosure relates generally to the prevention of disclosure of sensitive information. More specifically, one embodiment relates to the removal of metadata from artifacts that may accompany messages.

### BACKGROUND

The increased use of electronic communications has led to increased awareness regarding the unwanted disclosure of information to third parties. One type of disclosure that can result from electronic communication is via the disclosure of metadata. Metadata, or data about data, in one form is information about an electronic file that is created either automatically or by manual means and is stored and travels with the electronic file.

One example of metadata is information created, revised and stored in conjunction with an artifact. An artifact is an electronic file created from a software application. By way of non-limiting example, artifacts are documents, spreadsheets, text files, drawings, presentations, graphic works, or software code created from applications such as word processors, document publishing programs, photo editors, CAD programs, or code editors. During the creation and modification of artifacts, applications often automatically create and store information with the output electronic file, or artifact, such as creation date, modification date, content revisions, or the identity of the editor. This metadata information is stored and travels with the artifact as the artifact is copied, transmitted, or otherwise distributed.

Some users do not want to disclose the metadata that accompanies artifacts. In light of this need, methods and programs have been developed that remove metadata from artifacts. One such method of removing metadata from artifacts is a locally-based metadata removal application. This solution is a stand-alone metadata removal software that is installed on a computing device and removes metadata from artifacts.

The locally-based metadata removal application has disadvantages. Some disadvantages of a locally-based metadata removal application include that it requires the intervention of the user of the local computing device to set-up and utilize the metadata removal application. In addition, the metadata removal application occupies a portion of the storage capacity of the computing device. The locally-based metadata removal application can also perform slower and affect other applications or programs that are operating on the local computing device. Still further, the removal of metadata is limited to artifacts located on the local computing device.

Another method of removing metadata from an artifact is a remote metadata removal system. One example of a remote metadata removal system is depicted in FIG. 1. In this example, the remote metadata removal system allows for the removal of metadata from artifacts attached to emails. Emails are first created on local personal computers 14, on an interne email service 12, or on a mobile communication device 10. The email and attached artifact is sent from one of the sources to a communications server 16 that interprets the email and prepares the email and attached artifact to be delivered to a recipient. Before delivery, the email and artifact are routed to a metadata removal server 18. Based on instructions previously provided or based on a cleansing policy (that is often centrally controlled), metadata removal server 18 removes metadata from the artifact. The cleansed artifact and the email are then delivered to the intended recipient.

The remote metadata removal system also has disadvantages. A disadvantage of the remote metadata removal system of FIG. 1 is that a centralized cleansing policy is employed such that each artifact is categorized and the metadata is removed according to general instructions provided to the metadata removal server.

Thus, a need exists for a method and apparatus directed to overcoming the limitations of prior art solutions.

### SUMMARY

The instant disclosure describes techniques and apparatuses for the removal of metadata from artifacts that accompany messages. To this end, in one example, in a mobile communication device, a method for removing metadata from an artifact accompanying a message includes displaying at least one prompt via a user interface of the mobile communication device. Further, the method includes receiving, from a user of the mobile communication device via the user interface in response to the at least one prompt, metadata removal preference data. Cleansing instructions based on the metadata removal preference data are created and the message, the cleansing instructions, and the artifact are sent to a delivery system. The delivery system removes metadata from the artifact based on the cleansing instructions.

In another example, a mobile communication device includes a mobile transmitter, a user interface, a processing device, and memory. The processing device is operatively connected to the mobile transmitter and the user interface. The memory, in turn, is operatively connected to the processing device. Stored on the memory are instructions that, when executed, cause the processing device to display a prompt via a user interface on the mobile communication device and receive metadata removal data, from a user of the mobile communication device via the user interface in response to the prompt. Execution of the instructions further causes the processing device to create cleansing instructions based on the metadata removal preference data and send the message, an artifact, and cleansing instructions to a delivery system wherein the delivery system removes metadata from the artifact based on the cleansing instructions.

In another example, a method for removing metadata from an artifact accompanying a message includes receiving, by a processing device, a message, an artifact and cleansing instructions from a mobile communication device, wherein the cleansing instruction were created based on metadata removal preference data, the metadata removal preference data obtained via a user interface on the mobile communication device in response to a prompt displayed to a user of the mobile communication device. Further, metadata is removed from the artifact by the processing device based on the cleansing instructions and a cleansed artifact is created. The message and the cleansed artifact are sent from the processing device to a destination.

In one example, an apparatus for removing metadata from an artifact accompanying a message includes a receiver and transmitter and a processing device operatively connected to the receiver, transmitter and memory. The memory is operatively connected to the processing device and includes instructions, when executed, that cause the processing device to receive a message, an artifact, and cleansing instructions from a mobile communication device via the receiver, wherein the cleansing instructions were created based on metadata removal preference data that was obtained via a user interface on the mobile communication device in response to a prompt to a user of the mobile communication device. The instructions on the memory further cause the processing device to remove metadata from the artifact based on the cleansing instructions to create a cleansed artifact and send the message and the cleansed artifact from the processing device to a destination via the transmitter.

Using these methods and apparatuses for removing metadata allows individuals and organizations to exercise a greater degree of control over the distribution of information.

### BRIEF DESCRIPTION OF THE DRAWINGS

The features described in this disclosure are set forth with particularity in the appended claims. These features will become apparent from consideration of the following detailed description, taken in conjunction with the accompanying drawings. One or more examples are now described, by way of example only, with reference to the accompanying drawings wherein like reference numerals represent like elements and in which:

FIG. 1 is a depiction of a remote metadata removal system in accordance with prior art techniques;

FIG. 2 is a diagram illustrating a message and artifact(s) that may be operated upon in accordance with the various embodiments described herein;

FIG. 3 is a flowchart illustrating processing by a mobile communication device for the removal of metadata in accordance with the instant disclosure;

FIG. 4 is a flowchart illustrating processing by a processing device for the removal of metadata in accordance with the instant disclosure;

FIG. 5 is a block diagram of one example of an embodiment of a mobile communication device;

FIG. 6 is a block diagram of another example of an embodiment of an apparatus for the removal of metadata; and

FIG. 7 is a depiction of one example of a user interface according to the instant disclosure.

### DETAILED DESCRIPTION

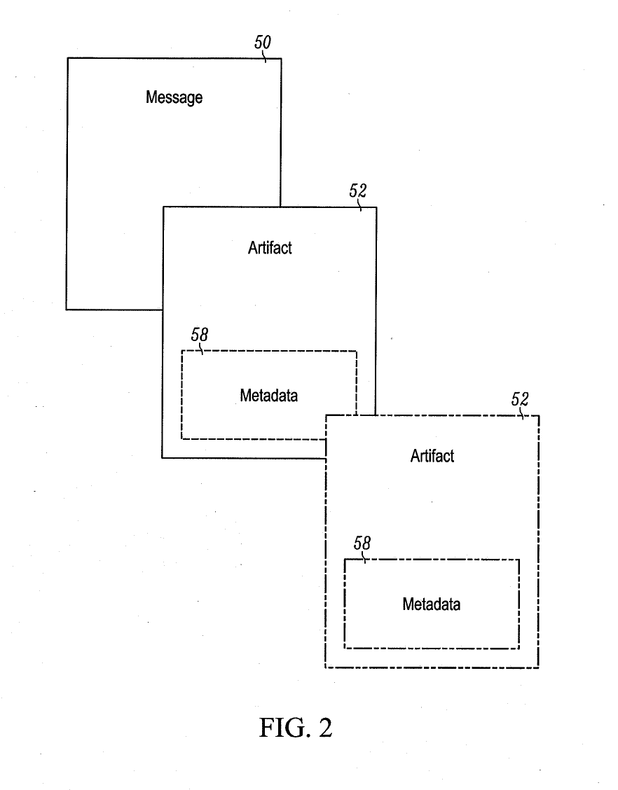

FIG. 2 is a diagram of a message 50 and accompanying artifact 52 that may be used in conjunction with the methods and apparatuses described further below. Message 50 can be any electronic communication. Some examples of message 50 are emails, instant messages, text messages, chat messages, and video conferencing exchanges. As is known to one of ordinary skill in the art, one or more artifacts often accompany messages. These artifacts, as described above, can be documents, photos or other electronic files that are sent with a message. Artifact 52 often includes metadata 58 either as discrete data appended to, or embedded within, the artifact 52. As described earlier, metadata 58 can include information regarding the creation, modification, and user interaction with artifact 52. The removal of metadata 58 is the subject of the methods and apparatuses described in more detail below.

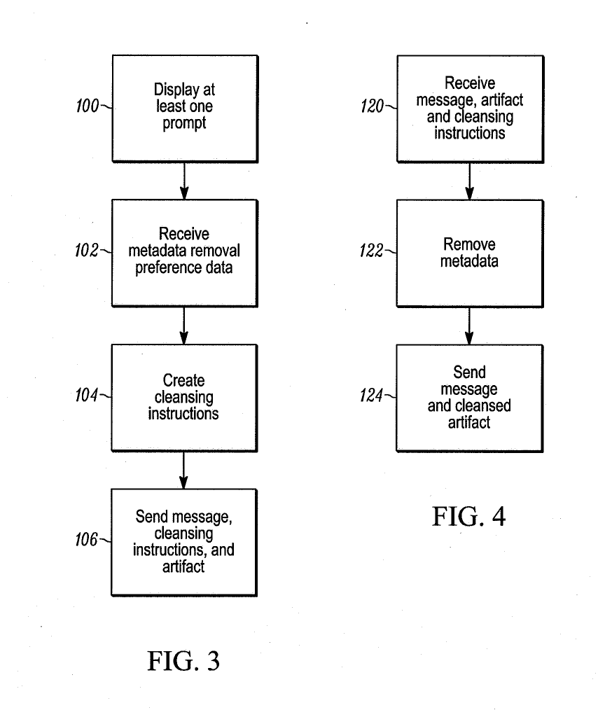

FIG. 3 is a flowchart of one example method for the removal of metadata 58 from an artifact 52. In this example method, the steps are completed on a mobile communication device. A mobile communication device can be any portable device capable of sending an electronic communication or message, typically via a wireless communication channel. Some non-limiting examples of mobile communication devices are mobile telephones, tablet computers, personal digital assistants, or hand-held media players. While the steps are described as being performed on a mobile communication device, the method can equally be applied to other electronic systems known to one of ordinary skill in the art.

Considering again FIG. 2, a message 50 and an artifact 52 with associated metadata 58 are first created prior to the steps shown in FIG. 3. The message 50 and accompanying artifact 52 are then sent to an intended destination or recipient. Mechanisms for creating and sending such messages and artifacts are well known in the art and need not be described in further detail here. Upon sending, the mobile communication device can obtain instructions regarding how a user of the mobile communication device would like to handle any metadata associated with an artifact 52. In one embodiment, a user manually manifests his/her intent by instructing the mobile communication device directly, i.e., without intervention by the mobile communication device. In another embodiment, the mobile communication device automatically detects the presence of artifact 52 accompanying message 50 and then solicits the user's input.

In the first alternative noted above, artifact 52 is not automatically detected. A user, instead, is able to decide how to handle metadata that may be associated with an artifact 52. In this example, the user invokes a metadata removal application on the mobile communication device. Invocation of the metadata removal application can be accomplished by any suitable means known to one of ordinary skill in the art such as through user input via a user input device. For example, the application used to create the message (such as, but not limited to, an email application) may include a user input mechanism that instructions the application to invoke a metadata removal application that, in turn, causes a prompt to be displayed for receiving the user's instructions regarding how metadata should be processed, if at all. In the second alternative noted above, the mobile communication device may automatically determine the need to ask the user about his/her metadata removal instructions for the message. This may be accomplished through the use of an application protocol interface (API) provided by the message creation application that may be queried (or subscribed to) regarding specific events, such as the user selecting a function that would cause the message to be sent or the occurrence of an attachment in a message. In this embodiment, the occurrence of the relevant event (i.e., attempting to send the message or attaching an artifact) can be used by the operating system of the mobile communication device to cause a prompt to be displayed for receiving the user's instructions regarding how metadata should be processed, if at all. Regardless of how the mobile communication device determines that it needs to inquire about the user's metadata removal instructions, the mobile communication device begins processing as shown in FIG. 3.

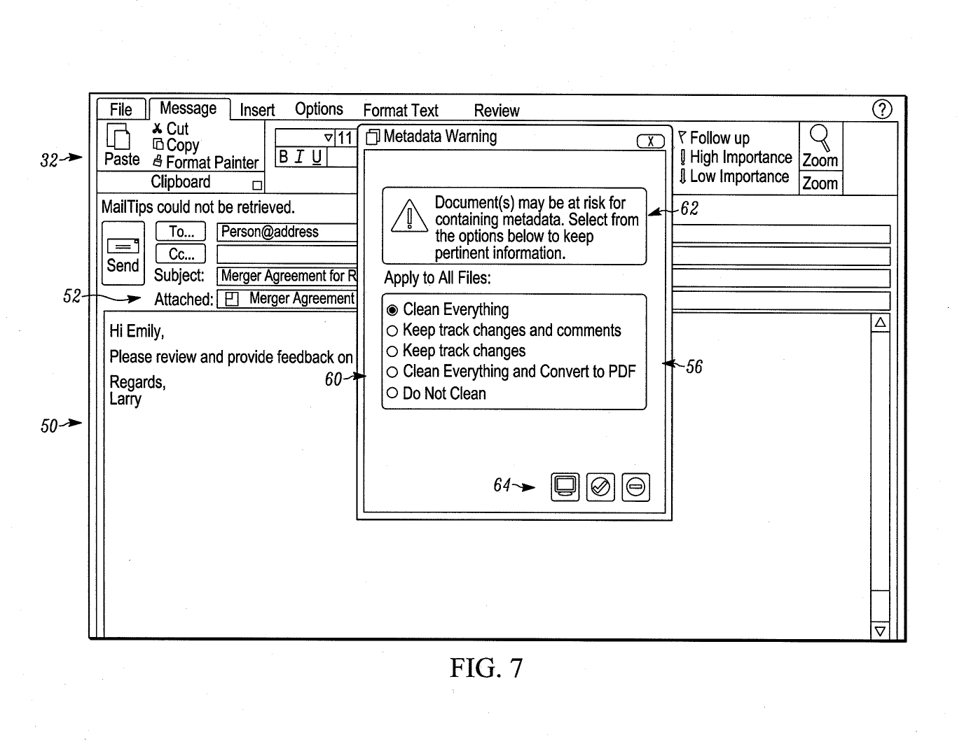

First, as shown by step 100, at least one prompt is displayed via a user interface of the mobile communication device. Prior to the display of a prompt, an artifact 52 may be detected or the user may invoke a metadata removal application on the mobile communication device as described above. A user interface of the mobile communication device can be any suitable component that is operative to convey information to a user and collect data from a user. A typical example of a user interface is a graphical user interface implemented using a touch screen of a mobile telephone but other user interfaces such as monitors or displays coupled with control buttons, roller-balls, keyboards, or mice can be used. Equally applicable to the methods described herein are user interfaces such as audible commands and voice recognition. Step 100 includes the display of at least one prompt. The display of at least one prompt can be automatic or user-initiated as described above. A prompt can be any cue displayed to user that elicits input from the user. One example of prompt 56 is shown is shown in FIG. 7. This example prompt 56 displayed on a user interface 32 is a window that includes radio buttons 60, metadata warning message 62, and selection buttons 64. Other types of prompts can be used as well as are known to one of ordinary skill in the art.

Referring once again to FIG. 3, at Step 102 metadata removal preference data is received. In this step, metadata removal preference data is received from a user of the mobile communication device in response to display of the prompt. Metadata removal preference data is information regarding any action that user wants to take regarding metadata that exists with respect to the artifact. In response to the display of the prompt in step 100, a user will input information that details how the user wants metadata to be removed from the artifact. In an embodiment, the user can choose not to remove metadata, to remove a portion of the metadata, or remove all metadata from the artifact. An example of this is shown in FIG. 7 where options are provided for the user to “Clean Everything”, “Keep Track Changes”, and “Do Not Clean”.

At step 104, cleansing instructions are created. The cleansing instructions are based on the metadata removal preference data received in step 102. The cleansing instructions are data that will be used by a downstream component when the metadata is removed from the artifact. In keeping with the embodiment noted above, the cleansing instructions may include information that the user wants all metadata removed, or only a portion of metadata removed (such as dates of revisions). The cleansing instructions are specific to each artifact for which they were created. In this manner, the removal of metadata can be customized for each artifact. The cleansing instruction can be a separate electronic file or a data field that can be embedded into the message or artifact. Further, the specific form of the cleansing instructions will necessarily depend on the capabilities of the downstream component to receive such instructions, e.g., a specific application program interface (API).

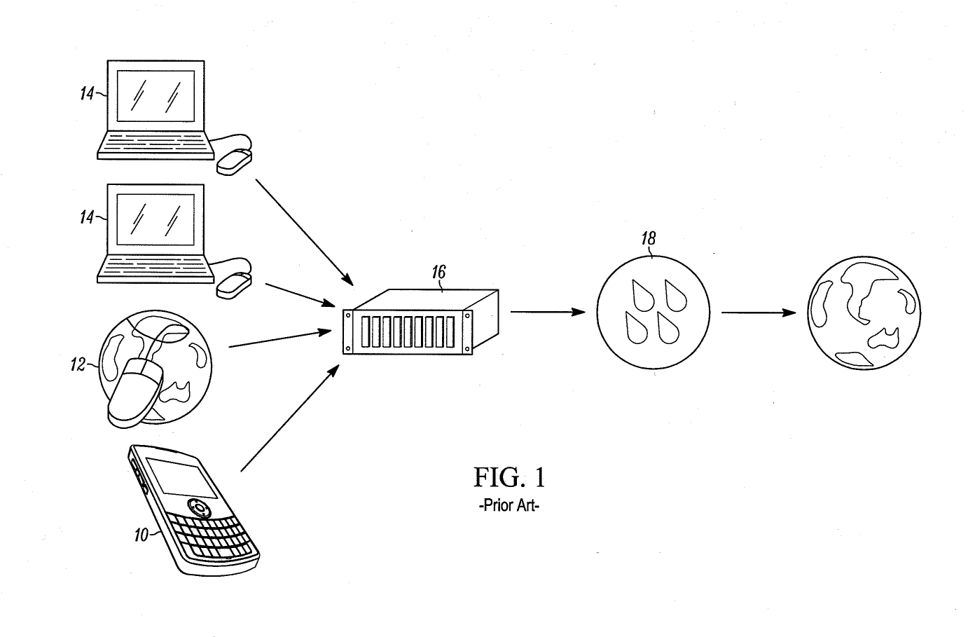

The message, the cleansing instructions, and the artifact are then sent at step 106. In this step the cleansing instructions created in step 104, the message, and the artifact are sent to a delivery system. The delivery system then removes the metadata from the artifact based on the cleansing instructions that were created from the metadata removal preference data received from the user. The delivery system is any suitable system that is capable of sending electronic communications and removing metadata from an artifact. The delivery system can be a single component or an interconnected group of components. A communications server 16 and a metadata removal server 18 as shown in FIG. 1 is one example of a delivery system. Other configurations including a multiple server network or a single server system can be used, and those having ordinary skill in the art will appreciate that the instant disclosure is not limited in this regard.

Once the message, the cleansing instructions and the artifact are sent to a delivery system and the delivery system removes metadata from the artifact. The delivery system completes the delivery of the message and the cleansed artifact to its intended recipient. Through this method, any undesirable disclosure of information in the form of metadata is prevented. Additionally, the method provides the customization of metadata removal for individual messages and artifacts and also does not require a metadata removal application to be installed on the local mobile communication device. This frees storage capacity on the mobile communication device for other uses.

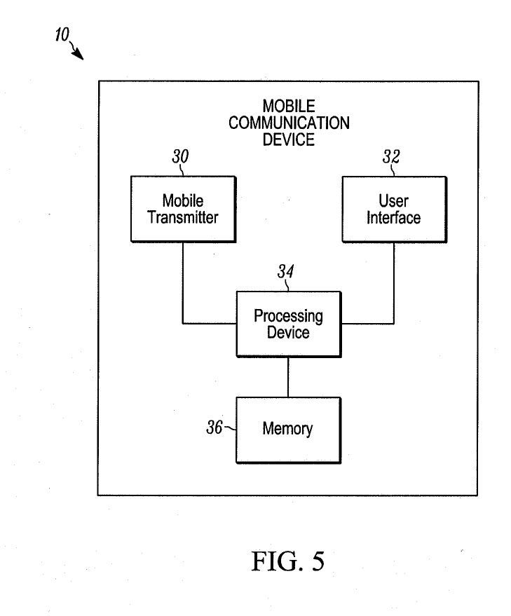

FIG. 5 depicts an example mobile communication device that is capable of implementing the method described above. Mobile communication device 10 includes mobile transmitter 30, user interface 32, processing device 34, and memory 36. Stored in memory 36, are executable instructions that may be passed as data to processing device 34 to cause the functionality described herein. Processing device 34 is operatively connected to both mobile transmitter 30, user interface 32, and memory 36. Mobile transmitter 30 is any suitable component capable of sending electronic communications over a network. Mobile transmitter 30 may also be capable of receiving electronic communications when implemented as part of a transceiver typically found in a mobile telephone. Processing device 34 may include one or more central processing units (CPUs), distributed processing circuitry, application specific integrated circuits (ASICs), state machines, discrete logic, or any other suitable processing circuitry known in the art or any combination thereof. Memory 36 may be any type of storage device known in the art, such as random access memory (RAM), read-only memory (ROM), programmable memory (PROM), erasable PROM (EPROM), electrically erasable PROM (EEPROM), flash memory, magnetic storage device (e.g. hard disks, floppy disks, magnetic tape), optical disc drives, or any other suitable memory now known or later developed.

FIG. 4 is a flowchart showing another example method for the removal of metadata. This example method includes the performance of steps from the perspective of a delivery system, such as the one depicted in FIG. 1 when modified in accordance with the teachings of the instant disclosure. Prior to the steps outlined in FIG. 4, the steps of the example method shown in FIG. 3 have been performed. As such, in step 120, the message, artifact and cleansing instructions are received. A communications server 16 shown in FIG. 1 is an example of a component that may perform step 120.

At step 122, metadata is removed. The metadata removal can be performed by any suitable means or application known in the art. A metadata removal server 18 as shown in FIG. 1 may perform step 122. Next, the message and the cleansed artifact are sent as shown in step 124. A metadata removal server or a communications server may perform this step in which the message and the artifact, with at least some metadata removed (i.e. a cleansed artifact), is sent to its intended destination.

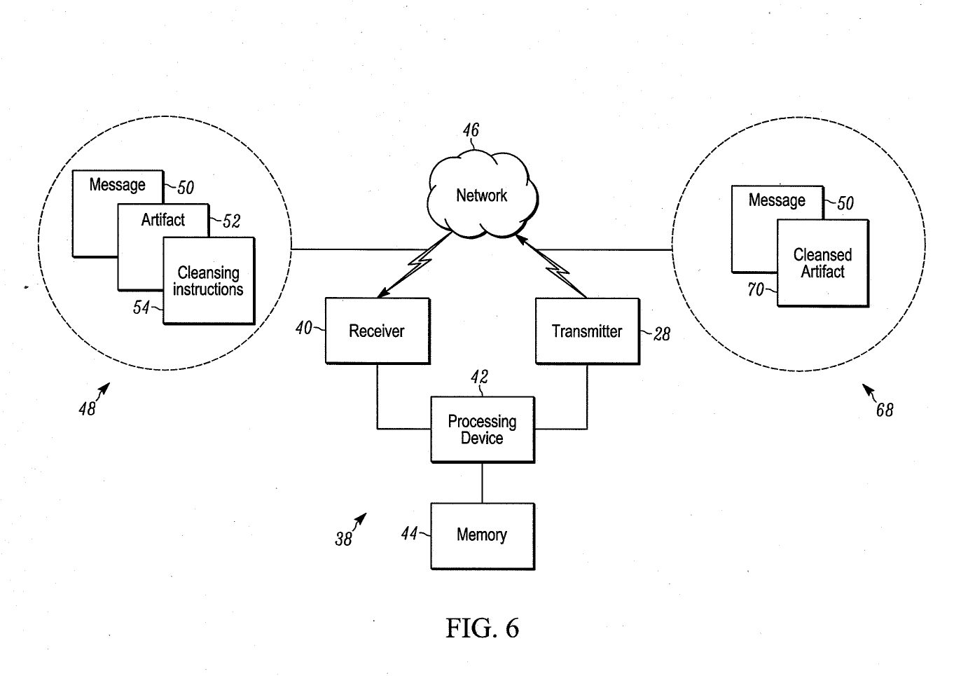

FIG. 6 is a diagram of an example apparatus that can carry out the steps of the method described in FIG. 4. The apparatus includes receiver 40, transmitter 28, processing device 42, and memory 44. Processing device 42 is operatively connected to receiver 40, transmitter 28 and to memory 44. Memory 44 includes executable instructions that may be executed by processing device 42 that causes the functionality previously described. Receiver 40 and transmitter 28 are in communication with network 46 or are capable of receiving electronic communications from network 46 and sending electronic communications from network 46. Network 46 can be any network know to one of ordinary skill in the art. Network 46 can be any suitable wired or wireless network such as a cellular telephone network, the World Wide Web, a local area network, a wide area network, ad-hoc wireless network, or personal area network (e.g. Bluetooth enabled network). Receiver 40 is any suitable component capable of receiving electronic messages and transmitter 28 is any suitable component capable of sending electronic messages. Receiver 40 and transmitter 28 may be separate individual components or may share components to result in the desired functionality. By way of non-limiting example, receiver 40 and transmitter 28 may be a mail server executing the functions of a message transfer agent application.

FIG. 6 also depicts a message packet 48. Message packet 48 includes message 50, artifact 52, and cleansing instructions 54. Message packet 48 is one example of the bundle of information received by the metadata removal apparatus 38. Further depicted is cleansed message packet 68. Cleansed message packet 68 includes message 50 and cleansed artifact 70. Cleansed artifact 70 is similar in most respects to artifact 52 except that it has had at least a portion of the original metadata removed. Cleansed message packet 68 is one example of the bundle of information sent from metadata removal system 38.

FIG. 7, as briefly described earlier, illustrates one example of a prompt 56 that is displayed via the user interface 32 of a mobile communication device. As noted above, prompt 56 comprises any cue used to elicit input from a user and may comprise virtually any mechanism for receiving user input. By way of non-limiting example, prompt 56 illustrated in FIG. 7 may include radio buttons 60, metadata warning message 62, and selection buttons 64. In this example, upon sending a message 50 with an accompanying artifact 52, prompt 56 is displayed. Metadata warning message 62 alerts the user that artifact 52 may contain metadata and asks the user to select how the metadata should be treated upon arriving at a metadata removal apparatus. Prompt 56 allows the user to select among varying levels of metadata removal that may include removing all metadata, removing a portion of metadata, or removing no metadata. The user can select among the varying levels of metadata removal and then select one of the selection buttons 64. The example illustrated in FIG. 7 is one way of displaying a prompt and receiving metadata removal preference data. Other types of prompts and interaction with a user of a mobile communication device such as voice prompting and commands, keyboard interactions, and touch shortcuts can also be used.

While example embodiments have been shown and described, those skilled in the art will appreciate that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. In a mobile communication device, a method for removing metadata from an artifact accompanying a message, the method comprising:
displaying at least one prompt via a user interface of the mobile communication device;
receiving, from a user of the mobile communication device via the user interface in response to the at least one prompt, metadata removal preference data;
creating cleansing instructions based on the metadata removal preference data; and
sending the message, the cleansing instructions, and the artifact to a delivery system;
wherein the delivery system removes metadata from the artifact based on the cleansing instructions.

2. The method of claim 1 wherein the mobile communication device is a wireless telephone or a portable computer.

3. The method of claim 1 wherein the at least one prompt comprises an indication to remove all metadata from the artifact.

4. The method of claim 1 wherein the at least one prompt comprises an indication to remove a portion of the metadata from the artifact.

5. The method of claim 1 wherein the at least one prompt comprises an indication to remove none of the metadata from the artifact.

6. The method of claim 1 wherein the message is an email or an instant message.

7. A computer-readable medium operatively connected to at least one processing device having stored thereon instructions that, when executed by the at least one processing device, cause the at least one processing device to:
display at least one prompt via a user interface on a mobile communication device;
receive, from a user of the mobile communication device via the user interface in response to the at least one prompt, metadata removal preference data;
create cleansing instructions based on the metadata removal preference data; and
send a message, the cleansing instructions, and an artifact to a delivery system;
wherein the delivery system removes metadata from the artifact based on the cleansing instructions.

8. The computer-readable medium of claim 7 wherein the mobile communication device is a wireless telephone or a portable computer.

9. The computer-readable medium of claim 7 wherein the at least one prompt comprises an indication to remove all metadata from the artifact.

10. The computer-readable medium of claim 7 wherein the at least one prompt comprises an indication to remove a portion of the metadata from the artifact.

11. The computer-readable medium of claim 7 wherein the at least one prompt comprises an indication to remove none of the metadata from the artifact.

12. The computer-readable medium of claim 7 wherein the message is an email or an instant message.

13. A mobile communication device comprising:
a mobile transmitter;
a user interface;
at least one processing device operatively connected to the mobile transmitter and the user interface; and
memory operatively connected to the at least one processing device having stored thereon instructions that, when executed by the at least one processing device, cause the at least one processing device to:
display at least one prompt via the user interface on the mobile communication device;
receive, from a user of the mobile communication device via the user interface in response to the at least one prompt, metadata removal preference data;
create cleansing instructions based on the metadata removal preference data; and
send the message, the cleansing instructions, and an artifact to a delivery system;
wherein the delivery system removes metadata from the artifact based on the cleansing instructions.

14. The device of claim 13 wherein the mobile communication device is a wireless telephone or a portable computer.

15. The device of claim 13 wherein the at least one prompt comprises an indication to remove all metadata from the artifact.

16. The device of claim 13 wherein the at least one prompt comprises an indication to remove a portion of the metadata from the artifact.

17. The device of claim 13 wherein the at least one prompt comprises an indication to remove none of the metadata from the artifact.

18. The device of claim 13 wherein the message is an email or an instant message.

19. A method for removing metadata from an artifact accompanying a message, the method comprising:
receiving, by a processing device, the message, the artifact, and cleansing instructions from a mobile communication device, wherein the cleansing instructions were created based on metadata removal preference data, the metadata removal preference data obtained via a user interface on the mobile communication device in response to at least one prompt displayed to a user of the mobile communication device;
removing, by the processing device, metadata from the artifact based on the cleansing instructions to create a cleansed artifact; and
sending the message and the cleansed artifact from the processing device to a destination.

20. The method of claim 19 wherein the mobile communication device is a wireless telephone or a portable computer.

21. The method of claim 19 wherein substantially all metadata is removed from the artifact in accordance with the cleansing instructions.

22. The method of claim 19 wherein a portion of metadata is removed from the artifact in accordance with the cleansing instructions.

23. The method of claim 19 wherein substantially none of the metadata is removed from the artifact in accordance with the cleansing instructions.

24. The method of claim 19 wherein the message is an email or an instant message.

25. A computer-readable medium operatively connected to at least one processing device having stored thereon instructions that, when executed by at the least one processing device, cause the at least one processing device to:
receive a message, an artifact, and cleansing instructions from a mobile communication device, wherein the cleansing instructions were created based on metadata removal preference data, the metadata removal preference data obtained via a user interface on the mobile communication device in response to at least one prompt displayed to a user of the mobile communication device;
remove metadata from the artifact based on the cleansing instructions to create a cleansed artifact; and
send the message and the cleansed artifact from the processing device to a destination.

26. The computer-readable medium of claim 25 wherein the mobile communication device is a wireless telephone or a portable computer.

27. The computer-readable medium of claim 25 wherein the at least one prompt comprises an indication to remove all metadata from the artifact.

28. The computer-readable medium of claim 25 wherein the at least one prompt comprises an indication to remove a portion of the metadata from the artifact.

29. The computer-readable medium of claim 25 wherein the at least one prompt comprises an indication to remove none of the metadata from the artifact.

30. The computer-readable medium of claim 25 wherein the message is an email or an instant message.

31. An apparatus for removing metadata from an artifact accompanying a message, the apparatus comprising:
a receiver and a transmitter;
at least one processing device operatively connected to the receiver and the transmitter; and
memory operatively connected to the at least one processing device having stored thereon instructions that, when executed by the at least one processing device, cause the at least one processing device to:
receive a message, an artifact, and cleansing instructions from a mobile communication device via the receiver, wherein the cleansing instructions were created based on metadata removal preference data, the metadata removal preference data obtained via a user interface on the mobile communication device in response to at least one prompt displayed to a user of the mobile communication device;
remove metadata from the artifact based on the cleansing instructions to create a cleansed artifact; and
send the message and the cleansed artifact from the processing device to a destination via the transmitter.

32. The apparatus of claim 31 wherein the mobile communication device is a wireless telephone or a portable computer.

33. The apparatus of claim 31 wherein the at least one prompt comprises an indication to remove all metadata from the artifact.

34. The apparatus of claim 31 wherein the at least one prompt comprises an indication to remove a portion of the metadata from the artifact.

35. The apparatus of claim 31 wherein the at least one prompt comprises an indication to remove none of the metadata from the artifact.

36. The apparatus of claim 31 wherein the message is an email or an instant message.
